(19) United States
(12) Patent Application Publication
(10) Pub. No.: US 2002/0169718 A1
(43) Pub. Date: Nov. 14, 2002

(54) System for improving the payment of child support to a payee parent

(76) Inventor: Daniel D. Alsofrom, Linwood, NJ (US)

Correspondence Address: SONNENSCHEIN NATH & ROSENTHAL, P.O. BOX 061080, WACKER DRIVE STATION, CHICAGO, IL, 60606-1080, US

(21) Appl. No.: 09/852,101

(22) Filed: May 9, 2001

(51) Int. Cl. G06F 17/60

(52) U.S. Cl. 705/40

(57) ABSTRACT

The present invention provides a system for improving the payment of child maintenance monies from a payor parent to a payee parent in a legal jurisdiction. The system administers a contract with the payee parent, wherein the contract guarantees the payment of child maintenance monies. For as long as the payor parent does not timely pay, the system pays the payee parent the child maintenance monies and enforces rights to payment obtained from the payee parent against the payor parent under applicable statutes of the legal jurisdiction. The associated method requires entering into the contract with the payee parent, receiving notice that the payor parent has not timely paid the child maintenance monies, paying the child maintenance monies for so long as the payor parent does not timely pay, and enforcing rights to payment under applicable statutes of the legal jurisdiction.

### BACKGROUND OF THE INVENTION

1. Field of the Invention

The invention relates to a system and method for improving the payment of child support to a payee parent.

2. Background Art

The absence of one parent in raising a family is a common situation in today's society due to divorce and out-of-wedlock childbirth. In these situations, the absent parent, the payor parent, remains responsible for at least partial support of the child left behind. Courts institute child support orders against payor parents to provide the child with the standard of living that the child would have enjoyed had the family been intact. Unfortunately, though, child support frequently goes unpaid.

Failure to pay child support pursuant to a child support order rarely is the result of a payor parent's inability to afford the child support. A review of state implemented child support guidelines reflects that the child support obligation of each parent is affordable by each parent because the obligation is based on the parent's earnings. Some of the reasons that a payor parent does not pay his or her child support obligation may include: that the payor parent is angry at the other party because of the family breakup; the payor parent is simply selfish and wants to be free of prior obligations; the payor parent wants to be free of the children or of a bad relationship; the payor parent feels like “a visitor” to the child rather than a parent and therefore believes he/she should not pay for a visitation “privilege”; and other reasons not related to the inability to afford the obligation.

As a result of this widespread failure to pay support, poverty has become endemic among mother-headed families presumably in relation to these large increases in single parent families. In 1995, 41.5% of the nearly 8.8 million families maintained solely by the mother with children under 18 had incomes below the poverty line. Child Support Enforcement Program, §8 Committee on Ways and Means, U.S. House of Representatives, 1998 Green Book (May 19, 1998).

In 1950, only a small minority of children were in one-parent families and many of the one-parent families were a result of the death of one parent. In the early 1970s, though, the majority of children needed aid due to the separation, divorce, or non-marriage between the two parents.

In response to the demographic trends, the Federal-State child support programs grew rapidly. In 1950, Congress amended the Aid to Families with Dependent Children (AFDC) law by requiring state welfare agencies to notify law enforcement officials when benefits were being furnished to a child who had been abandoned by one of her parents. Local officials were then responsible for undertaking to locate payor parents and make them pay child support. In 1975, these efforts were expanded when the Child Support Enforcement and Paternity Establishment Program (CSE) was enacted. This program was intended by Congress to reduce public expenditures on welfare by obtaining support from payor parents on an ongoing basis to help non-AFDC families get support so that they could stay off public assistance. Consequently, basic responsibility for administering child support enforcement programs is left to the states, but the federal government plays a major role in funding, monitoring, and evaluating the state programs, and among other things, giving direct assistance to states in locating absent parents and obtaining support payments. In turn, each state has different procedures in place to deal with payor parents in their state.

By 1996, there were an estimated 11.7 million single -parent families with children under the age of 18. In 1996, one-parent families comprised nearly 32% of all families. The corresponding share in 1970 was 13%. Although the number of families with a divorced mother has tripled since 1970, the number with a mother who has never married has increased fifteen-fold from 248,000 to 3,829,000. In these latter cases, paternity must be determined before the other parent has a legal obligation to financially support the child. As a result, in 1996, three billion dollars were spent by state child support programs to collect twelve billion dollars in child support. The combined federal-state program had more than 51,600 employees. A sum of $3.93 was collected for every dollar of administrative expense. As of 1999, twenty-one billion dollars of reported child support obligations were to exchange hands that year alone between the payor parent and the payee parent. Only about 52% of that amount was actually distributed. However, the 52% of child support obligations collected in 1999 represents a significant increase from prior years. Child Support Enforcement FY 1999 Preliminary Data Report, Office of Child Support Enforcement, 1999. Therefore, many single parents are left raising their children alone, both emotionally and financially.

Although the states' laws provide draconian measures to improve the ability to collect payment, support still goes unpaid. The individuals working for the government that are responsible for collecting child support are understaffed, underpaid, and overwhelmed by the amount of work involved. Further, significant amounts of taxpayers' dollars are being spent on AFDC families who do not receive their child support payments and on the programs initiated by the CSE. While federal and state governments have increased the amount of resources for collection of child support, collection of child support is still extremely difficult. Estimates in 1989 suggested that approximately 30% of all child support cases involve interstate residency of the payee parent and payor parents. With increased mobility in today's society, these numbers are increasing and, as a result, interstate enforcement of support obligations is becoming increasingly difficult.

Individual states have employed various other measures not related to the CSE program to increase the collection of child support payments. In Massachusetts, for example, the child support enforcement division posts on its website “deadbeats of the month”, parents “wanted on the web”, and the “ten most wanted.” This service may be effective for the individual cases that get posted, but the service cannot be effectively employed for each of the thousands of individuals in the state that fail to make timely payments.

As for self-help, payee parents very rarely engage private legal assistance in recovering unpaid child support. Family law attorneys, however, have the expertise and resources to effectively and efficiently assist payee parents in recovering unpaid child support from deadbeat payor parents. Family law attorneys are more familiar with the most effective enforcement procedures than the government agencies are and also have more financial and technical resources than the government to assist in locating the payor parent. Typically, payee parents do not want to pay attorneys for the collection of support in arrears or they are frightened by seeking legal representation on their own. Certainly, the states have not sought assistance from the bar either. Thus, while family law attorneys may have an arsenal of legal remedies available to assist these desperate parents, they have not been given the widespread opportunity to do so. Thus, there is a need to provide payee parents with an inducement to employ family law attorneys in the collection of child support.

In view of the increased mobility, among other factors, organized cooperation between attorneys and investigators is also needed to assist in child support enforcement. Currently, there are no known networks linking attorneys with other specialists within and/or between each of the states to assist in child support collection. Thus, there is a need for an organized structure to provide payee parents with all of the resources necessary to recover child support payments.

### SUMMARY OF THE INVENTION

The invention provides a system for use by an end user that improves the payment of child maintenance monies from a payor parent to a payee parent. The end user may be a third party insurer that enters into a contract with a payee parent. The system may include records of information relating to the payment of child maintenance monies and a means for administering the insurance contract. The system further comprises a means for paying the payee parent and a means for enforcing the third party insurer's rights obtained through subrogation. The means for enforcing may include a listing of specialists organized into a network by the third party insurer to assist in enforcing the third party insurer's rights.

The invention transfers child support enforcement responsibility from the government to the third party insurer. The government has typically been responsible for assisting payee parents in the collection of child maintenance monies. The introduction of third party insurers into the enforcement process relieves the government from expending its resources and time in this arena. As a result, the government's time and finances may be expended in other needed areas. Also, third-party insurers may collaborate with specialists to insure the payment of child maintenance monies and thereby increase the amount of collections made.

The invention further involves a method for improving the payment of child maintenance monies from a payor parent to a payee parent. The method may include (1) entering into a contract with the payee parent that guarantees the payment of child maintenance monies; (2) receiving notice that the payor parent has not timely paid the child maintenance monies; (3) paying the child maintenance monies; and (4) enforcing the third party insurer's rights to payment against the payor parent.

### DETAILED DESCRIPTION

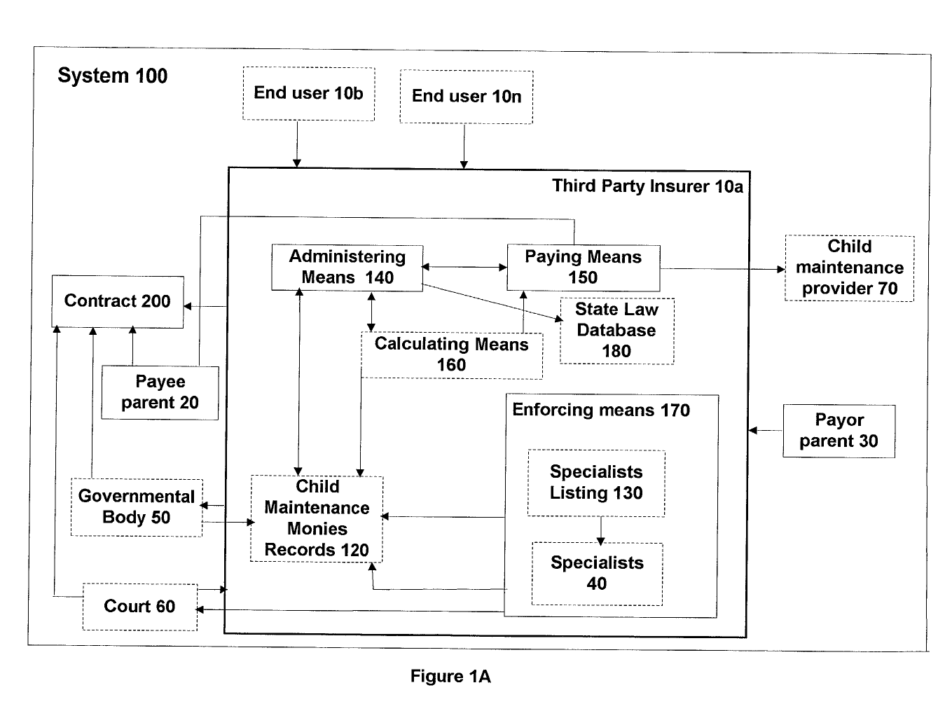

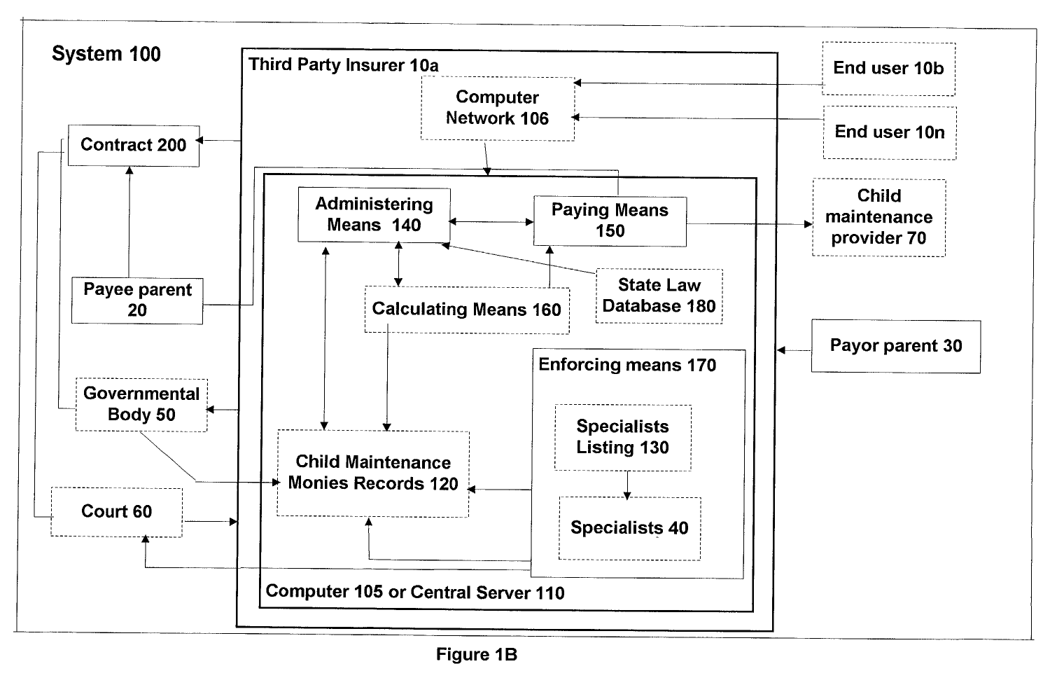

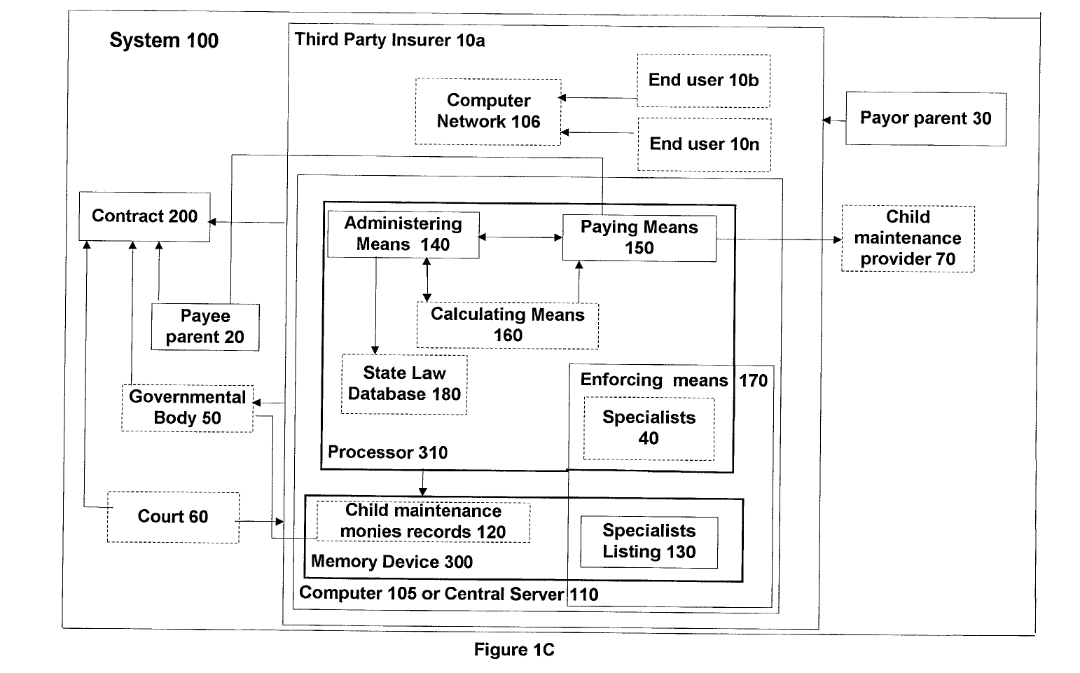

FIG. 1 is a block overview of the various components of the inventive system. In particular, a system 100 may include a third party insurer 10a, a payee parent 20, a payor parent 30, specialists 40, a governmental body 50, a court 60, and a contract 200. System 100 may include several end users 10 including third party insurer 10a and end users 10b-n.

A third party insurer 10a may include but is not limited to an insurance company or any other type of guarantor. The insurance company may be, among other possibilities, a private “for profit” corporation or an entity of the government.

Payee parent 20 may be a person with an order of support for the care of a minor or other dependent (hereinafter “minor child”). The payee parent 20 may not necessarily be a parent. The payee parent 20 may be one who is to receive support from a payor parent 30 for taking over primary care and maintenance of the minor child. Payor parent 30 may be the parent of a minor child without legal custody but legally responsible for the financial support of the minor child. The term “parent” encompasses all parents, including but not limited to biological parents, parents by adoption, relatives, step parents, surrogate parents, psychological parent, foster parent, and en loco parentis.

Specialists 40 may include but are not limited to attorneys 41 and investigators 42 (see FIG. 5). In one approach, the attorney 41 may be an in-house or staff attorney of the third party insurer 10a or an attorney contracting with the third party insurer 10a. The investigators 42 may include but are not limited to private investigators and skip-tracers that are staffed or outsourced by the third party insurer 10a.

Governmental body 50 may include but is not limited to any state or federal administrative body, legislature or organization. For example, an administrative body may be the State's child support enforcement agency. Further, the court 60 may include but is not limited to any federal, state, local, or administrative court.

A child maintenance provider 70 may include but is not limited to a health insurance provider, life insurance provider, an educational facility, and day care.

The system 100 improves the payment of child maintenance monies from the payor parent 30 to the payee parent 20. The system 100 may include the functions of case initiation, case management, financial management, enforcement, security, and reporting. For example, the system 100 may be used to keep an accurate identification of payments, to promptly distribute money to payee parents 20 or child maintenance providers 70, to monitor for past due payments, and to enforce the third party insurer's rights obtained from the payee parent 20 when payments are past due. Implementing these functions can facilitate locating payor parents 30 and monitoring child maintenance cases.

The third party insurer 10a maintains the system 100 that offers payee parents 20 contracts 200 guaranteeing the payment of child maintenance monies in return for an insurance premium. In a preferred approach, the payment of child maintenance monies may include obligations for present and future payments. Although less desirable, the payment of child maintenance monies may also include obligations for past due payments. The payment of child maintenance monies will generally be delineated in a court order, typically child support orders. A child support order legally obligates the payor parent 30 to provide financial support for their children, including the amount of the obligation, and how it should be paid. Other court orders may include but are not limited to consent orders, divorce judgments, domestic violence orders, and non-dissolution orders. Child maintenance monies may include but are not limited to expenses for a child's food, shelter, clothing, medical attention, and education, day care, a life insurance policy for the benefit of the child, a health insurance policy, and a dental insurance policy.

In the contract 200, the third party insurer 10a guarantees the payment of child maintenance monies for a predetermined period of time. In one approach, the third party insurer 10a guarantees the payment of child maintenance monies for a period of one year wherein the contract may be renewed at the end of the one year period. In another approach, the contract 200 guarantees the entire amount of the child maintenance monies designated by a court order. The amount, though, may be subject to change during the period of the contract 200 if the amount of child maintenance monies is modified during the period of the contract 200. The third party insurer 10a may choose not to be responsible for guaranteeing the payment of child maintenance monies beyond the age of majority despite the definition of emancipation in the legal jurisdiction. In the contract 200, the payee parent 20 would most often be required to agree to allow the third party insurer 10a to enforce the payee parent's rights with any means required by law. By agreement, the payee parent's right may then become the rights of the third party insurer 10a. The payee parent 20 may waive all rights to dictate or institute collection methods against the payor parent 30. Further, the payee parent 20 would agree to cooperate with the third party insurer 10a to obtain support payments in the event that the payor parent 30 does not make the payment. In one approach, the payor parent 30 may also enter into the contract 200.

In some systems, the contract 200 may be required by law. Any governmental body 50, including but not limited to Congress or any individual state or local legislature, may require that all payee parents 20 on the receiving end of a court order relating to the payment of child maintenance monies enter into a contract 200 with a third party insurer 10a that guarantees the payment of the child maintenance monies. In another approach, the court 60 originating the court order may require the contract 200 between the payee parent 20 and the third party insurer 10a. Further, in one approach, the governmental body 50 or the court 60 may require the contract 200 only under particular circumstances, such as in high risk situations.

After the payee parent 20 enters into the contract 200 with the third party insurer 10a, the payee parent 20 may be insured to receive the payment of child maintenance monies. In one approach, the governmental body 50, such as the State's child support enforcement agency, maintains child maintenance monies records 120. The third party insurer 10a may provide a specialists listing 130, an administering means 140, a paying means 150, a calculating means 160, and an enforcing means 170 to assist in carrying out the inventive system. In this approach, when the payor parent 30 fails to make a payment, the payee parent 20 must first notify the governmental body 50. The governmental body 50 may then transfer the information to the third party insurer 10a. In another approach, the third party insurer 10a may instead maintain the child maintenance monies records 120 as well as provide the specialists listing 130, the administering means 140, the paying means 150, the calculating means 160, and the enforcing means 170. In this embodiment, the payee parent directly notifies the third party insurer 10a. In yet another approach, the contract 200 designates whether the payee parent 20 must first notify the governmental body 50 or the third party insurer 10a for assistance in collection of child maintenance monies.

The child maintenance monies records 120 may include information 121 relating to the payment of child maintenance monies. The information 121 relating to the payment of child maintenance monies may include but is not limited to the name and address of the payee parent 20 and the child; the age of the child; the name, address, Social Security number and occupation of the payor parent 30; the type of, amount of, and due dates for the child maintenance monies; the names of friends and relatives or organizations to which the payor parent 30 may belong; information about income and assets; and any other relevant information about the payor parent 30. The child maintenance monies records 120 may be organized by filing systems or computer databases, or other measures as generally known in the insurance industry, and may be maintained by the administering means 140.

The administering means 140 tracks the information 121 from the child maintenance monies records 120 and may be used to notify the end users 10, such as the third party insurer 10a, when the payment of child maintenance monies is due or overdue. In one approach, the administering means 140 notifies the end user 10 on the first day payment is due as well as fourteen days after the payment is due. The administering means 140 may also maintain full records of collections from the payor parent 30 and of disbursements to the payee parent 20. The administering means 140 may include but is not limited to personnel staffed or outsourced by the third party insurer 10a, computers, and subsystems of a computer network. When the administering means 140 detects an overdue payment or receives notice of an overdue payment from the payee parent 20, the administering means 140 signals the third party insurer 10a of the obligation to pay the payee parent 20 or a child maintenance provider 70 the amounts due at that time in accordance with the contract 200.

The administering means 140 may include the calculating means 160 to calculate the amount of the payment due to the third party insurer 10a from the payor parent 30. The calculating means 160 retrieves the information 121 from the child maintenance monies records 120 to calculate the amount of payment overdue, taking into account each overdue amount as well as the amount of accrued interest on the overdue payments. The accrued interest may be based on a compound or flat, fixed or variable interest rate, depending upon the law of the appropriate jurisdiction. Further, the calculating means 160 factors in any amount due for specialists' fees, including attorney's fees, incurred in recovering payments as allowed by the appropriate laws in the jurisdiction. Calculating means may include but is not limited to personnel staffed or outsourced by the third party insurer 10a, computers, calculators, and subsystems of a computer network, if allowed by law. The administering means 140 may also interface with a state law database 180 that details particular recovery measures and damages allowed in each jurisdiction as discussed above.

When the obligation to pay the payee parent 20 arises, the administering means 140 alerts a paying means 150 that the payment is due. The paying means 150 accesses the child maintenance monies records 120 to retrieve information 121 including, but not limited to, the payee parent's address, the child maintenance provider's address, and the amount of payment. The paying means 150 then generates the payment and the correspondence with the payee parent 20 or the child maintenance provider 70, whomever may be applicable. It is to be understood that any mode of correspondence may be applied to deliver the payment, including but not limited to hand-delivery, U.S. mail, certified mail, FedEx, electronic mail via the Internet, and direct deposit. Paying means 150 may include but is not limited to personnel staffed or outsourced by the third party insurer 10a, a computer, and a subsystem of a computer network.

The enforcing means 170 pursues the third party insurer's rights obtained from the payee parent 20 against the payor parent 30. The enforcing means 170 may include a specialists listing 130. The specialists listing 130 includes information 131 regarding specialists 40 utilized in the collection of child maintenance monies. The specialists listing 130 may be compiled in any organized system including but not limited to reference books, such as Martindale Hubbell, computer databases, websites, such as lawyers.martindale.com and www.lawoffice.com. For example, the specialists' information 131 may be organized in the specialists listing 130 by specialty and legal jurisdiction; therefore, the specialists information 131 can be retrieved by an end user's search for a particular specialist 40 in a particular legal jurisdiction. The information 131 may be additionally or alternatively organized along other schemes, including but not limited to the fees charged by the specialist 40, the availability of the specialist 40, and the size of the specialists' firm.

A network of specialists 40 may be set up within one legal jurisdiction or within multiple legal jurisdictions. The network of specialists 40 may include the specialists 40 listed in the specialists listing 130. The network of specialists 40 in multiple legal jurisdictions permits specialists 40 in one legal jurisdiction to employ the services of specialists 40 in other legal jurisdictions. Such services may be needed when the payor parent 30 is located outside of the legal jurisdiction in which the payee parent 20 resides. A network of specialists 40 located in multiple jurisdictions helps eliminate the costs of travel and the fees related to finding out of state services to assist in enforcing the third party insurer's rights obtained from the payee parent 20. When the payor parent 30 or the payor parent's assets are located in another state, an attorney 41 licensed in that state is required. However, attorneys 41 are typically licensed in only one or two states. In one approach, attorney 41 licensed to practice in the payor parent's state would have to be hired to enforce any orders against local property or payor parents 30. In another approach, the attorney 41 licensed to practice in the payor parent's state may take the order and enter it there. The child maintenance monies records 120 may be transferred to the attorney 41 in the other state to assist in enforcement. In one approach, the network of specialists 40 is selected by the third party insurer 10a prior to entering into the contract 200 with the payee parent 20.

It is understood that the system 100 may utilize automated procedures, electronic processes, and/or computer-driven technology. For example, FIG. 1a depicts a computer 105 utilized in the present inventive system 100. The computer 105 may host various sub-systems (i.e. programs) that operate to form an optional part of the inventive system and method. As shown in the exemplary configuration of FIG. 1a, computer 105 may host child maintenance monies records 120, specialists listing 130, administering means 140, paying means 150, calculating means 160, and enforcing means 170. Particularly, in an implementation of the inventive system 100 associated with the Internet, each of these sub-systems may be implemented using Java applets in a WINDOWS 9x environment. However, use of this environment may not be required as part of the invention and other programming languages and user-interface approaches may also be used to facilitate data entry and execute the various computer programs that make up the inventive system and method.

The child maintenance monies records 120 of the computer 105 stores data in fields including information 121 relating to the payment of child maintenance monies. The child maintenance monies records 120 may be SQL-based, Oracle-based, or text-based. Each component of information 121 may comprise a field in the child maintenance monies records 120 so that when an end user 10 opens a new profile for a new client/payee parent 20, the end user 10 may be prompted to fill in at least some of these fields.

The administering means 140 of the computer 105 interfaces with the child maintenance monies records 120, the calculating means 160, and the paying means 150 to accomplish the functions described above.

The specialists listing 130 of the computer 105 may include data in fields including information 131 regarding specialists 40 utilized in the collection of child maintenance monies. This specialists listing 130 may be SQL-based, Oracle-based, or text-based. Each component of information 131 may comprise a field in the specialists listing 130 so that the specialists information 131 can then be retrieved by an end user's prompt for a particular specialist 40. For example, an end user may search for an attorney in Cook County, Illinois by entering “attorney” and “Cook County” in the required fields. As would be understood by those of ordinary skill in the art, the specialists listing 130 may be distributed across multiple devices in a disk array. In another embodiment, the specialists listing 130 automatically retrieves the information 131 regarding specialists 40 when particular fields are entered in the child maintenance monies records 120. For example, once a child's name is entered into the child maintenance monies records 120 with at least some of the above information 121 relating to the payment of child maintenance monies, the child maintenance monies listing 120 and the specialists listing 130 interface to retrieve the appropriate specialists 40 in the selected jurisdiction. For example, a child A with a payee parent B living in State X has a payor parent C living in State Y. When child A and payee parent B's information 121 is entered into child maintenance monies listing 120, specialists listing 130 automatically retrieves appropriate specialists 40 in both State X and State Y.

In one embodiment, the system 100 may further include at least one central server 110. End users 10 connect to the central server 110 through a computer network 106. The central server 110 may preferably be a general purpose computer system such as an IBM compatible, Apple, Unix type workstation, or equivalent computer (using a processor that may selectively be an Intel, AMD, Cyrix, Motorola 68XXX or PowerPC series, Compaq Digital Alpha, Sun, HP, IBM, Silicon Graphics, or other type of equivalent processor). The central server 110 may be connected to the computer network 106. Computer network 106 may be any computer network that allows multiple computer systems to communicate with each other such as a Local Area Network (LAN), WAN, WAP (wireless application protocol), Intranet or the Internet, using standard communications protocols. It should also be noted that computer network 106 could comprise the public telephone network with central server 110 acting as a dial-up bulletin board. It is contemplated that various end user computers or computer networks (with their associated user computers) will connect with central server 110 using at least commonly available networking protocols. Of course, each user computer or network can be operably connected to central server 110 using any of the foregoing types of networking approaches and none need to connect via the same networking approach.

As shown in FIG. 1a, third party insurer 10a, as well as end users 10b-n, comprise external data sources and are operably connected to computer network 106. Each of these end users 10 may include some network interface that allows for communications with computer network 106 and may include any Internet capable software program such as Netscape Navigator, Microsoft Internet Explorer, Mosaic, or their equivalents.

In one embodiment depicted in FIG. 1b, the computer system 105 includes a memory device 300 and a processor 310. The memory device 300 is configured to store information relating to the payor parent 20 and the payee parent 30, store information relating to the payment, and store information relating to specialists 40. The processor 310 communicates with the memory device 300 and is configured to track information relating to the payment, notify the end user 10 of the due date for the payment, receive a request for at least one specialist 40, coincide the information relating to the payee parent 30 and the payor parent 20 with the information relating to the at least one specialist 40, and retrieve the information relating to the at least one specialist 40.

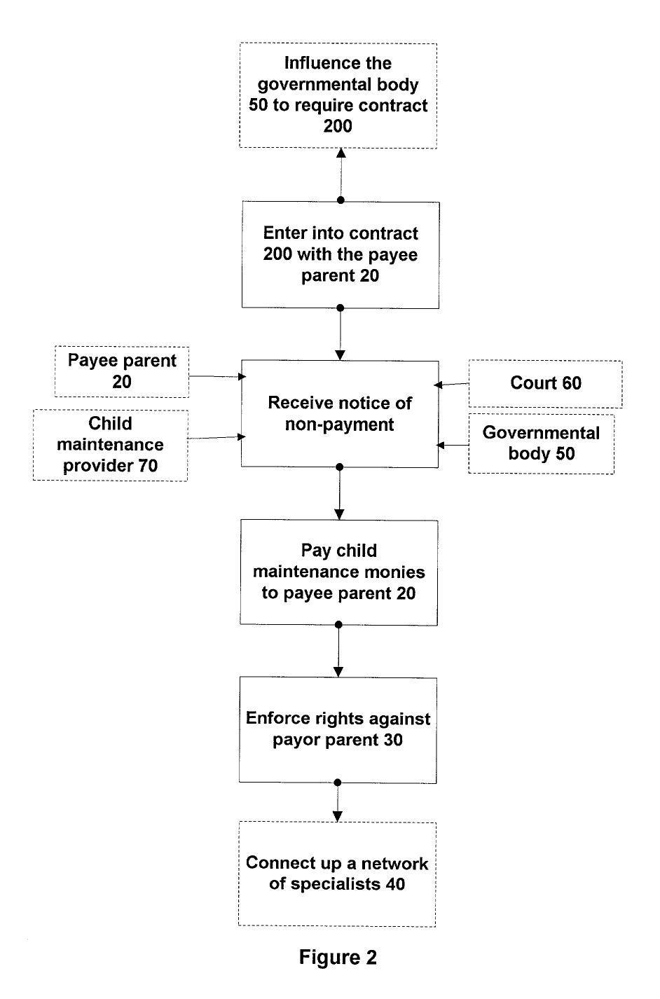

The system 100 of the present invention may be utilized in the following method. Referring to FIG. 2, once a payee parent 20 receives an order from a court 60 for the payment of child maintenance monies, the third party insurer 10a avails itself to the payee parent 20 to assist in the payment of the child maintenance monies. The third party insurer 10a enters into the contract 200 with the payee parent 20. In return, the payee parent 20 assigns or subordinates his/her support rights to the third party insurer 10a. In one approach, the third party insurer 10a influences the government to require the contract as a predicate to various proceedings (i.e. divorce and paternity). In entering into the contract 200 with the payee parent 20, the third party insurer 10a receives the information 121 relating to the maintenance of child maintenance monies and enters the information 121 into the child maintenance monies records 120. The administering means 140 monitors the information 121 relating to the child maintenance monies until the contract 200 terminates. The third party insurer 10a continuously updates the child maintenance monies records 120 as new information 121 is received. For example, in one approach, if a payee parent 20 receives a payment from the payor parent 30, the payee parent 20 may be contractually obligated to notify the third party insurer 10a. The third party insurer 10a, then, updates the child maintenance monies records 120 to reflect receipt of the payment. If a payment is received late, the child maintenance monies records 120 reflect the amount of days late and transfers the amount to the calculating means 160 to calculate any interest that may have accrued. The amount of interest that accrued may be transferred to the administering means 140 to notify the third party insurer or stored in the child maintenance monies records 120 until a predetermined amount of money requires collection.

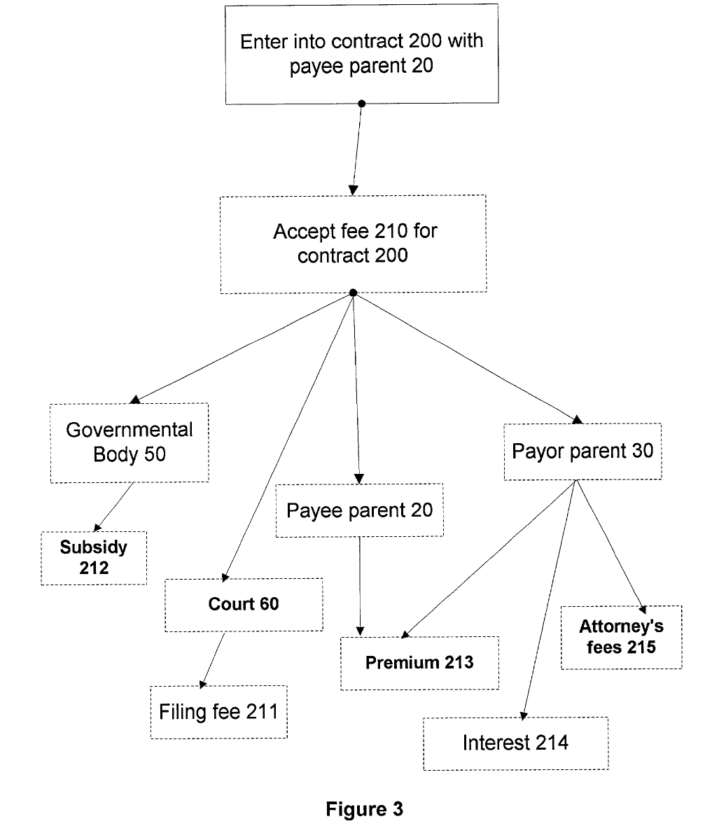

Referring to FIG. 3, the third party insurer 10a may charge a fee 210 in consideration of the contract 200 for their services. The fee 210 may be based, for example, upon a percentage of the maximum amount of the child maintenance monies paid over the course of one year. The fee 210 may be payable by either the payee parent 20, the payor parent 30, the court 60, or by the governmental body 50 or any combination of the foregoing. In one approach, the clerk of the court 60 may pay the fee 210. The clerk may utilize a portion of the filing fee 211 for the child maintenance order to pay the fee 210 to the third party insurer 10a. In another approach, the governmental body 50 provides a subsidy 212 from state or federal funds. In yet another approach, when the third party insurer 10a comprises an insurance company, the fee 210 may include a premium 213. The premium 213 may be paid by the payee parent 20, the payor parent 30, or both. When the premium 213 is paid by the payee parent 20 and the payor parent 30, the payee parent 20 and the payor parent 30 may be responsible for a percentage equal to the percentage of responsibility designated in the court order. For example, barring any modifications to the court order, the maximum amount John, a payor parent 30, would have to pay in reference to child maintenance monies is $7,220.00 per year. As an arbitrary number, should the third party insurer 10a charge 5% of the amount that John would have to pay over the course of one year, or the length of the policy, then John and Jane, the payee parent 20, would be charged $361.00 for the insurance policy for one year. In one approach, the $361.00 premium could be divided by John assuming 75% of the responsibility and Jane assuming 25% of the responsibility, percentages already determined by the court 60 based on John's income and Jane's income in relation to the total of both parties' incomes.

Other fees 210 received by the third party insurer 10a may include interest 214 on past due payments as provided by law and/or contract. Third party insurers 10a may charge the payor parent 30 interest 214 on a past due payment equal to a percentage of the amount of overdue support. Interest 214 on the late payment may be charged to payor parents 30 and may be collected after the full amount of the support has been paid to the payee parent 20. Other fees 210 received by third party insurers 10a may include attorneys fees 215.

Referring back to FIG. 2, after the third party insurer 10a enters into a contract 200 with the payee parent 20, the third party insurer 10a receives notice that the payor parent 30 has failed to make a timely payment. The third party insurer 10a may receive notice from the payee parent 20, the governmental body 50, the court 60, or the child maintenance provider 70. The third party insurer 10a may verify the that payment has not been made by contacting the governmental body 50 or court 60. In one approach, verifying may include accessing listings maintained by the governmental body 50 or the court 60. Notice that the payment has not been made may include but is not limited to a sworn affidavit from the payee parent 20 or a certified statement from the governmental body 50 or court 60. The contract may also include a penalty for false reporting. In another approach, the third party insurer 10a must receive notice from the governmental body 50 or the court 60 before its obligation under the contract 200 arises.

Once the third party insurer 10a receives notice that the payor parent 30 has not timely paid, the third party insurer 10a may be contractually obligated to pay the payee parent 20 or the child maintenance provider 70 the amount of child maintenance monies currently due, unless the contract 200 states otherwise. In one approach, the third party insurer 10a may not pay the payee parent 20 until it receives notice from at least one of the following: the payee parent 20, the court 60, the governmental body 50, or the child maintenance provider 70 that the payor parent 30 has not timely paid. The third party insurer 10a then makes the payment to the payee parent 20 or to the child maintenance provider 70. In one approach, the third party insurer 10a may be not required to pay the payee parent 20 the amount of overdue payments until a payment from the payor parent 30 is over fourteen days past due. The payment of the child maintenance monies to the payee parent 20 or the child maintenance provider 70 continues for so long as the payor parent 30 does not timely pay. If a payor parent 30 makes a timely payment in the amount designated by the court order, the third party insurer 10a may be relieved of its contractual duties for that particular payment.

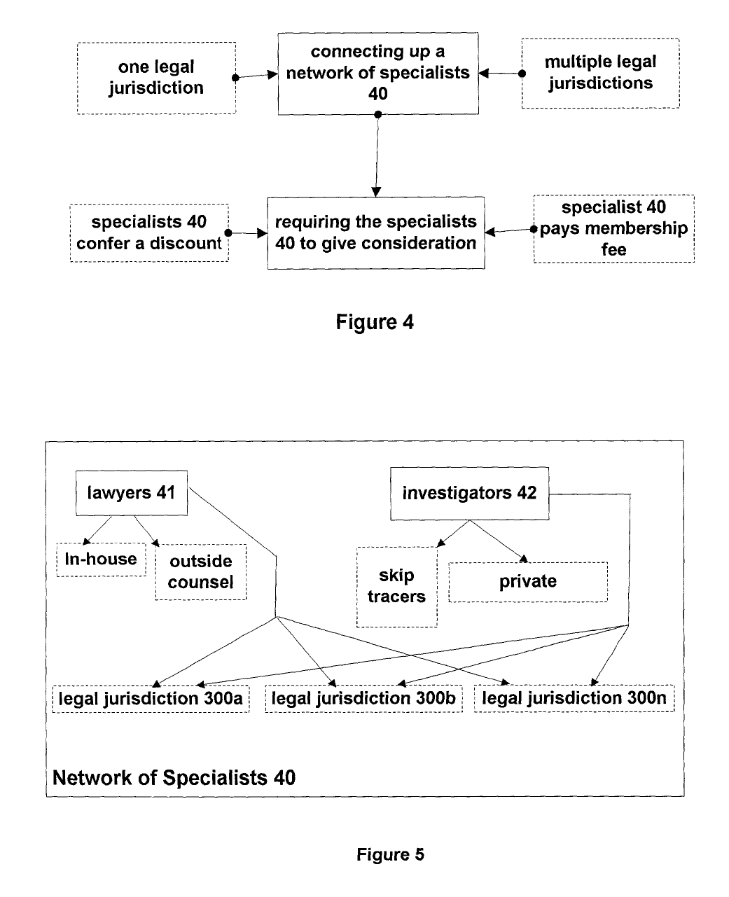

When the payor parent 30 fails to make a timely payment and the third party insurer 10a pays the payee parent 20, the third party insurer 10a, pursuant to subrogation, enforces the payee parent's rights to collect the child maintenance monies from the payor parent 30. The third party insurer 10a may utilize the network of specialists 40 to enforce the payee parent's rights to payment. As depicted in FIG. 5, he third party insurer 10a may create by contract its own network of specialists 40 or may outsource to another firm that connects specialists 40 into one network. The third party insurer 10 may compensate the specialists 40 participating in the network with a flat fee or on an hourly basis. The compensation will typically be derived from costs recoverable from the payor parent 30. Further, as depicted in FIG. 4, the specialists 40 may give consideration to join the network. The consideration may include but is not limited to the payment of an initial membership fee or charging the third party insurer 10a a reduced rate for the specialists services.

The third party insurer 10a may utilize the network of specialists 40 to enforce the payee parent's rights 20. First, the third party insurer 10a searches for an attorney in the specialists listing 130. The third party insurer 10a then selects, contacts, and employs the appropriate attorney 41 according to the network's membership terms. The attorney 41 may first attempt to locate the payor parent 30 for collection. In pursuing a payor parent 30 for collection, the third party insurer 10a or the attorney 41 accesses information 121 relating to the payor parent 30, such as the last known residence or employment location, from the child maintenance monies records 120. The third party insurer 10a or the attorney 41 may also seek to obtain further information and documents from the payee parent 20 or other sources, including but not limited to the Federal Parent Locator System.

If the third party insurer 10a or the attorney 41 cannot locate the payor parent 30 with the information 121 provided by the payee parent 20, the third party insurer 10a or attorney 41 may locate the payor parent 30 through the use of the investigator 42. The investigator 42 may be selected from the network of specialists 40 in a manner similar to the selection of the attorney 41. Locating the payor parent 30 may further include selecting attorneys 41b-n or investigators 42b-n in a different legal jurisdiction and employing the specialists 40 according to the membership contract terms.

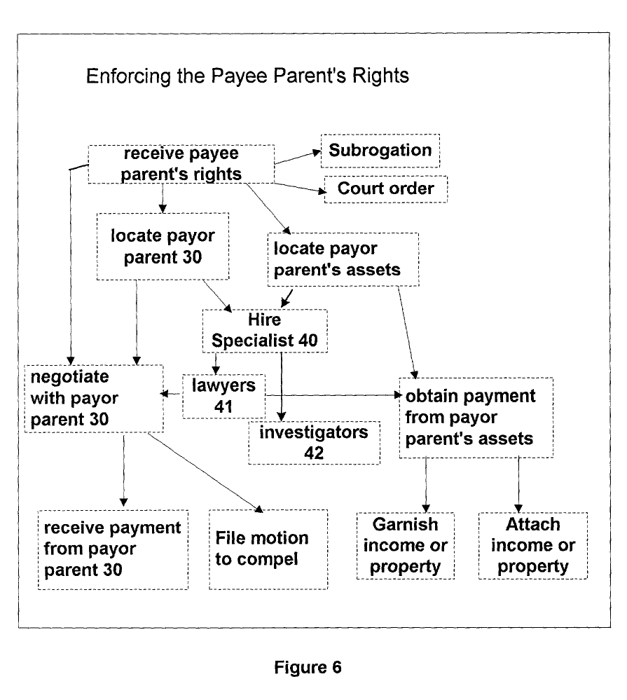

Referring to FIG. 6, once the payor parent 30 is located, the attorney 41 collects the payment of child maintenance monies from the payor parent 30. Collection may be made by asking the payor parent 30 to voluntarily make the payment or by filing a motion to compel payment of the child maintenance monies in the appropriate legal jurisdiction. Relief sought in the motion may include but is not limited to the base amount of the child maintenance monies, interest on the past due payments, attorneys' fees, investigation fees, court costs, as well as immediate arrest and incarceration until payment is made in full.

If the third party insurer 10a, the attorney 41, or the investigator 42 cannot locate the payor parent 30 or if the payor parent 30 refuses to comply with the court order, the attorney 41 may pursue the payor parent's assets. For example, the attorney 41 may attach or garnish the payor parent's income or property, whichever may be applicable. Attachment and garnishment are terms well known in the art. Income may include but is not limited to salaries, wages, commissions, severance pay, royalties, bonuses, interest and dividends, income derived from business/partnerships, social security, veteran's benefits, insurance benefits, workers' compensation, unemployment compensation, pensions, annuities, income from trusts, capital gains, spousal support from a third party, contractual agreements, income from life insurance or endowment contracts, income from an interest in an estate, lottery or gambling winnings, prizes or awards, and net rental income.

The attorney 41 for the third party insurer 10 may institute one or several other legal collection procedures, aside from garnishment or attachment, to recover the amount of payment from the payor parent's assets. Collection procedures are well known in the art and may include but are not limited to regular billings, delinquency notices, liens on property, seizure and sale of property, reporting arrearages to credit agencies, seizure of state and federal income tax funds, revocation of various types of licenses (drivers', business, occupational, recreational) or passports, criminal nonsupport or civil or criminal contempt, and federal imprisonment, fines or both.

During this step, the attorney 41 may employ the services of the investigator 42 or may utilize the third party insurers' 10a own staff to locate the payor parent's assets. Further, attorneys 41b-n and investigators 42b-n from other legal jurisdictions may also be needed to recover from the payor parent 30. These attorneys 41b-n and investigators 42b-n are selected and employed according to the membership contract terms. After the collection from the payor parent 30 is made, the provider may notify the governmental body 50 or the court 60 that the child maintenance monies have been paid.

In one example, enforcing the third party insurer's rights to payment obtained from the payee parent 20 may be delayed until the third party insurer 10a a receives a predetermined amount of notices that the payor parent 30 has not timely paid. This delay provides an efficient system to aggregate the resources to a one-time collection rather than recovery of numerous individual payments.

In one example, the third party insurer 10a does not pay the payee parent 20 the child maintenance monies but does enforce the payee parent's rights subject to the contract 200. The same enforcement means and methods are applied as stated above; however, the third party insurer 10a assists the payee parent 20 in receiving the payment of child maintenance monies directly from the payor parent 30. The third party insurer 10a may still require the payment or receipt of fees 210 for the contract 200 as described above.

While the present invention may be embodied in many different forms, the invention can best be understood with reference to the accompanying figures with the understanding that the present disclosure is considered only as an exemplification of the principles of the invention and is not intended to limit the invention to any approach illustrated herein. Further, the method and system are described above in relation to the collection of child maintenance monies for one child. However, for purposes of this invention, the description equally applies to the collection of child maintenance monies for more than one child.

1. A method for improving the payment of child maintenance monies from a payor parent to a payee parent in a legal jurisdiction comprising:
(a) entering into a contract with the payee parent, the contract guaranteeing the payment of child maintenance monies;
(b) receiving notice that the payor parent has not timely paid the child maintenance monies;
(c) paying the child maintenance monies for so long as the payor parent does not timely pay; and
(d) enforcing rights to payment obtained from the payee parent against the payor parent under applicable statutes of the legal jurisdiction.

2. The method of claim 1, further comprising connecting up a network of specialists in at least one legal jurisdiction.

3. The method of claim 2, further comprising requiring the specialists to pay a membership fee for admission into the network.

4. The method of claim 2, further comprising requiring the specialists to confer a discount of fees for their services.

5. The method of claim 1, further comprising connecting up a network of specialists in at least one legal jurisdiction in a computer system.

6. The method of claim 1, wherein enforcing rights to payment further comprises calculating in a computer system the amount of interest that has accrued on the payments.

7. The method of claim 1, further comprising influencing the government to require the contract.

8. The method of claim 1, further comprising accepting consideration for the contract from the government.

9. The method of claim 1, further comprising accepting a portion of a filing fee as consideration for the contract.

10. The method of claim 1, further comprising accepting the interest that accrues on the payment of child maintenance monies as consideration for the contract.

11. The method of claim 1, wherein enforcing rights to payment further comprises receiving the rights from the payee parent by subrogation.

12. The method of claim 1, wherein enforcing rights to payment further comprises locating the payor parent's assets.

13. The method of claim 12, wherein locating the payor parent's assets further comprises hiring an investigator from a network of specialists.

14. The method of claim 12, wherein enforcing rights to payment further comprises obtaining payment derived from the payor parent's assets.

15. The method of claim 2, wherein enforcing rights to payment further comprises hiring a lawyer from the network of specialists.

16. A system for use by an end user that improves the payment of child maintenance monies from a payor parent to a payee parent in a legal jurisdiction comprising:
(a) means for administering a contract with the payee parent, the contract guaranteeing the payment of child maintenance monies;
(b) means for paying the child maintenance monies for so long as the payor parent does not timely pay; and
(c) means for enforcing rights to payment obtained from the payee parent against the payor parent under applicable statutes of the legal jurisdiction.

17. The system of claim 16, wherein a portion of the end users are employed by a third party insurer and the third party insurer has an internal computer network, the computer network comprising a central server housing the means for administering, the means for paying, and the means for enforcing.

18. The system of claim 16, wherein the administering means monitors due dates for the payment of the maintenance monies.

19. The system of claim 16, further comprising means for calculating an amount of child maintenance monies due when the payor parent does not timely pay.

20. The system of claim 16, wherein the means for enforcing further comprises means for locating a specialist.

21. The system of claim 20, wherein the means for locating a specialist elicits information relating to child maintenance monies from the end user to identify the specialist in the legal jurisdiction.

22. The system of claim 20, wherein the means for locating a specialist comprises a listing of specialists.

23. A computer system for enforcing rights to payment obtained from a payee parent against a payor parent, comprising:
(a) a memory device, the memory device configured to:
store information relating to the payee parent and the payor parent,
store information relating to the payment,
store information relating to specialists; and
(b) a processor in communication with the memory device, the processor configured to:
track information relating to the payment,
notify an end user of the due date for the payment,
receive a request for at least one specialist,
coincide the information relating to the payee parent and the payor parent with the information relating to the at least one specialist, and
retrieve the information relating to the at least one specialist.
